(19) United States
(12) Patent Application Publication
(10) Pub. No.: US 2023/0055746 A1
(43) Pub. Date: Feb. 23, 2023

(54) DISPLAYS WITH DUAL-PIXEL DRIVERS

(71) Applicant: X Display Company Technology Limited, Dublin (IE)

(72) Inventors: Murat Ozbas, Penfield, NY (US); Ronald S. Cok, Rochester, NY (US); Matthew Alexander Meitl, Durham, NC (US)

(21) Appl. No.: 17/884,212

(22) Filed: Aug. 9, 2022

Related U.S. Application Data
(60) Provisional application No. 63/234,073, filed on Aug. 17, 2021.

(51) Int. Cl. G09G 3/32; G09G 3/34

(52) U.S. Cl. CPC G09G 3/32; G09G 3/3426; G09G 2310/0262; G09G 2300/0439

(57) ABSTRACT

A dual-pixel-driver display includes pixels distributed in an array of rows and columns defining a display area and a dual-pixel driver disposed within the display area. Ones of the pixels are grouped in mutually exclusive first and second pixel clusters. The dual-pixel driver comprises a driver input, a first driver output, and a second driver output. The first driver output and the second driver output are both commonly responsive to the driver input. The first driver output drives the pixels in the first pixel cluster and the second driver output drives the pixels in the second pixel cluster.

### PRIORITY APPLICATION

This application claims the benefit of U.S. Provisional Patent Application Ser. No. 63/234,073, filed on Aug. 17, 2021, the disclosure of which is hereby incorporated by reference herein in its entirety.

### FIELD OF THE DISCLOSURE

The present disclosure relates to flat-panel display architectures having pixel control circuits disposed within the display area.

### BACKGROUND OF THE DISCLOSURE

Flat-panel displays are widely used in conjunction with computing devices, in portable electronic devices, and for entertainment devices such as televisions. Such displays typically employ an array of pixels distributed over a display substrate to display images, graphics, or text. In a color display, each pixel includes light emitters that emit light of different colors, such as red, green, and blue. For example, liquid crystal displays (LCDs) employ liquid crystals to block or transmit light from a backlight behind the liquid crystals and organic light-emitting diode (OLED) displays rely on passing current through a layer of organic material that glows in response to the current. Displays using inorganic light-emitting diodes (LEDs) as pixel elements are also in widespread use for outdoor signage and have been demonstrated in a 55-inch television.

Displays are typically controlled with either a passive-matrix (PM) control scheme employing electronic control circuitry external to the pixel array or an active-matrix (AM) control scheme employing electronic control circuitry in each pixel on the display substrate associated with each light-emitting element. Both OLED displays and LCDs using passive-matrix control and active-matrix control are available. An example of such an AM OLED display device is disclosed in U.S. Pat. No. 5,550,066.

In a PM-controlled display, each pixel in a row is stimulated to emit light at the same time while the other rows do not emit light, and each row is sequentially activated at a high rate to provide the illusion that all of the rows emit light simultaneously. In contrast, in an AM-controlled display, data is concurrently provided to and stored in pixels in a row and the rows are sequentially activated to load the data in the activated row. Each pixel emits light corresponding to the stored data when pixels in other rows are activated to receive data so that all of the rows of pixels in the display emit light at the same time, except the row loading pixels. In such AM systems, the row activation rate can be much slower than in PM systems, for example divided by the number of rows. Active-matrix elements are not necessarily limited to displays and can be distributed over a substrate and employed in other applications requiring spatially distributed control.

Active-matrix circuits are commonly constructed with thin-film transistors (TFTs) in a semiconductor layer formed over a display substrate and employing a separate TFT circuit to control each light-emitting pixel in the display. The semiconductor layer is typically amorphous silicon or poly-crystalline silicon and is distributed over the entire flat-panel display substrate. The semiconductor layer is photolithographically processed to form electronic control elements, such as transistors and capacitors. Additional layers, for example insulating dielectric layers and conductive metal layers are provided, often by evaporation or sputtering, and photolithographically patterned to form electrical interconnections, or wires. In some implementations, small integrated circuits (ICs) with a separate IC substrate are disposed on a display substrate and control pixels in an AM display. The integrated circuits can be disposed on the display substrate using micro-transfer printing, for example as taught in U.S. Pat. No. 9,930,277.

For both PM and AM displays, relatively large display substrates having wires with limited electrical conductivity inhibit power, ground, and signal distribution and these signals can degrade over the display substrate, leading to difficulties in proper pixel control. Such problems become increasing problematic as the display substrate size and the number of pixels increase. There is a need, therefore, for display systems and architectures that provide improved signal distribution over relatively large displays.

### SUMMARY

Embodiments of the present disclosure provide displays, display systems, and display architectures that can operate at greater frequencies and with reduced power. The present disclosure includes, among various embodiments, a dual-pixel-driver display comprising pixels distributed in an array of rows and columns defining a display area, wherein ones of the pixels are grouped in a mutually exclusive first pixel cluster and second pixel cluster, and a dual-pixel driver disposed within the display area, the dual-pixel driver comprising a driver input, a first driver output, and a second driver output, the first driver output and the second driver output both commonly responsive to signals provided by the driver input. The first driver output is electrically connected to the first pixel cluster to drive the ones of the pixels in the first pixel cluster and the second driver output is electrically connected to the second pixel cluster to drive the ones of the pixels in the second pixel cluster.

According to embodiments of the present disclosure, the pixels comprise light controllers and the light controllers are controllable with passive-matrix control signals provided at least in part by the dual-pixel driver or the pixels comprise light controllers and the light controllers are controllable with active-matrix control signals provided at least in part by the dual-pixel driver. Each pixel can comprise a pixel controller responsive to the active-matrix control signals. Each of the pixels can comprise an inorganic light-emitting diode. The inorganic light-emitting diode can comprise a bare unpackaged die with a separate, individual, and independent LED substrate and a broken (e.g., fractured) or separated tether.

According to some embodiments, ones of the pixels in each of the rows can be grouped in a mutually exclusive first row pixel cluster and second row pixel cluster and the display comprises a dual-pixel driver for driving the first row pixel cluster and the second row pixel cluster. Ones of the pixels in each of the columns can be grouped in a mutually exclusive first column pixel cluster and second column pixel cluster and the display comprises a dual-pixel driver for driving the first column pixel cluster and the second column pixel cluster. Ones of the pixels in each of the rows can be grouped in a mutually exclusive first row pixel cluster or second row pixel cluster, ones of the pixels in each of the columns can be grouped in a mutually exclusive first column pixel cluster or second column pixel cluster and the display can comprise a dual-pixel driver for driving the first row pixel cluster and the second row pixel cluster and a dual-pixel driver for driving the first column pixel cluster and the second column pixel cluster. According to some embodiments, a dual-pixel-driver display can comprise a row cluster controller for controlling the first row pixel cluster and the second row pixel cluster and a column cluster controller for controlling the first column pixel cluster and the second column pixel cluster. The row cluster controller and the column cluster controller can be disposed in a common integrated circuit or can be disposed in separate integrated circuits.

According to some embodiments of the present disclosure, the number of pixels in the first pixel cluster can equal the number of pixels in the second pixel cluster.

According to some embodiments of the present disclosure, the first driver output and the second driver output can be separately enabled.

Some embodiments of the present disclosure, comprise multiple pairs of mutually exclusive first pixel clusters and second pixel clusters. The first driver output is electrically connected to the first pixel clusters to drive the ones of the pixels in the first pixel clusters and the second driver output is electrically connected to the second pixel clusters to drive the ones of the pixels in the second pixel clusters.

According to some embodiments of the present disclosure, a dual-pixel-driver display comprises a cluster controller disposed within the display area and the cluster controller comprises the dual-pixel driver. The cluster controller can comprise a bare unpackaged die with a separate, individual, and independent cluster-controller substrate and a broken (e.g., fractured) or separated tether. The display controller can provide active-matrix signals to the cluster controller.

According to some embodiments of the present disclosure, the pixels are grouped into first pixel clusters and second pixel clusters and the first pixel clusters and the second pixel clusters are mutually exclusive, the display comprises a respective dual-pixel driver disposed within the display area, the respective dual-pixel driver comprising a respective driver input, a respective first driver output, and a respective second driver output, the respective first driver output and the respective second driver output both commonly responsive to one or more signals provided by the respective driver input, and the respective first driver output is electrically connected to one of the first pixel clusters to drive the pixels in the one of the first pixel clusters and the respective second driver output is electrically connected to one of the second pixel clusters to drive the pixels in the one of the second pixel clusters. Embodiments of the present disclosure can comprise a cluster controller disposed within the display area, wherein the cluster controller comprises the dual-pixel driver and wherein the cluster controller is operable to control more than one pixel cluster among the first pixel clusters and the second pixel clusters. According to some embodiments, (i) the number of first pixel clusters is less than the number of pixels in the first pixel cluster (ii) the number of second pixel clusters is less than the number of pixels in the second pixel cluster, or (iii) both (i) and (ii). Embodiments of the present disclosure comprise multiple cluster controller and each of the cluster controllers drives different ones of the first pixel clusters and the second pixel clusters.

According to some embodiments of the present disclosure, the pixels and the dual-pixel driver are comprised in a backlight and each of the pixels can correspond to a local-dimming zone of the backlight.

According to some embodiments of the present disclosure, a dual-pixel-driver backlight for a display comprises pixels distributed in an array of rows and columns defining a display area, wherein ones of the pixels are grouped in a mutually exclusive first pixel cluster or second pixel cluster, and a dual-pixel driver disposed within the display area, the dual-pixel driver comprising a driver input, a first driver output, and a second driver output, the first driver output and the second driver output both commonly responsive to signals provided by the driver input. The first driver output can be electrically connected to the first pixel cluster to drive the ones of the pixels in the first pixel cluster and the second driver output can be electrically connected to the second pixel cluster to drive the ones of the pixels in the second pixel cluster.

Embodiments of the present disclosure provide active and passive display control methods and architectures that enable improved distribution of control signals with reduced power for flat-panel displays.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIGS. 1-7 are schematic plan views of cluster controllers and pixels in a display according to illustrative embodiments of the present disclosure;

FIGS. 8A-8D are schematics of a dual-pixel driver and light-emitting diodes according to illustrative embodiments of the present disclosure; and

FIG. 9 is a schematic of a dual-pixel driver and pixels comprising light-emitting diodes according to illustrative embodiments of the present disclosure;

FIG. 10 is a schematic of a dual-pixel driver and pixel array according to illustrative embodiments of the present disclosure; and

FIGS. 11A-11D are perspectives of substrates according to illustrative embodiments of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The figures are not drawn to scale since the variation in size of various elements in the Figures is too great to permit depiction to scale.

### DETAILED DESCRIPTION OF CERTAIN EMBODIMENTS

Embodiments of the present disclosure provide light-controlling information displays and backlights that require less power and can operate at higher frequencies or frame rates. As used herein, the generic term ‘display’ refers to both an information display that shows information, such as an image, text, or video, to a viewer, such as a micro-LED display, and to a local-area-dimming backlight that provides structured illumination to a light-valve display such as a liquid crystal display (LCD). Each pixel of a backlight can variably illuminate multiple pixels in an LCD thereby providing local-area dimming. Light-controlling displays can comprise organic light-emitting diode displays, liquid-crystal displays, and inorganic light-emitting diode displays, for example comprising micro-light-emitting diodes (micro-LEDs). For conciseness, the word ‘display’ is used in the following. Unless otherwise clear from context, where a ‘display’ is described, analogous embodiments of a backlight, with or without corresponding light control feature(s), such as an LCD layer, present, are also contemplated.

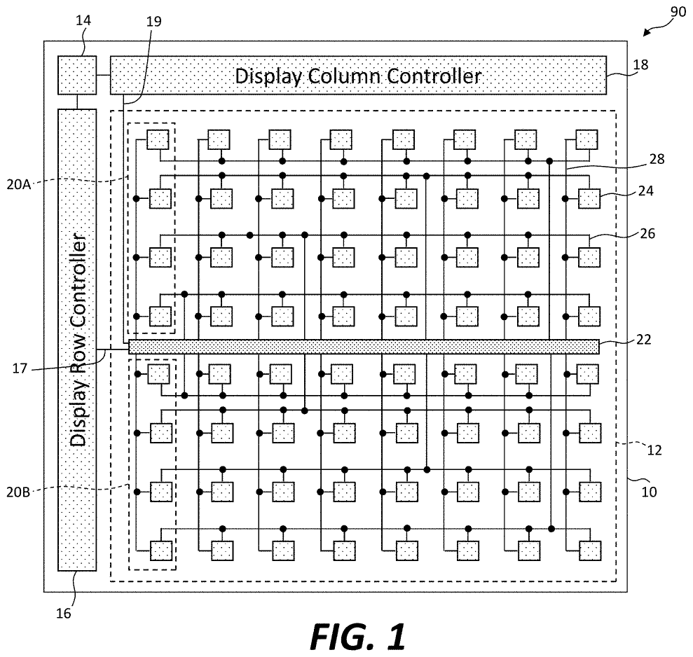

According to some embodiments of the present disclosure and as illustrated in FIG. 1, a dual-pixel-driver display 90 comprises pixels 24 distributed in an array of rows and columns defining a display area 12, for example on a display substrate 10. The array of pixels 24 can be a regular array. As used herein, display pixels 24 (generally referred to as pixels 24) control light to display an image; in contrast, image pixels specify the luminance of pixels in an image and can be input to dual-pixel-driver display 90. Pixels 24 are grouped in mutually exclusive first and second pixel clusters 20A, 20B (collectively pixel clusters 20) so that no pixel 24 in first pixel cluster 20A is in second pixel cluster 20B and no pixel 24 in second pixel cluster 20B is in first pixel cluster 20A. Dual-pixel-driver display 90 can comprise multiple pairs of first and second clusters 20A, 20B and each pixel 24 is grouped into one of the multiple first clusters 20A or one of the second clusters 20B, where the first cluster 20A and the second cluster 20B of a pair of first and second clusters 20A, 20B comprise mutually exclusive groups of pixels 24. In some embodiments, first clusters 20A are not mutually exclusive or second clusters 20B are not mutually exclusive so that a pixel 24 can be grouped into more than one first cluster 20A or into more than one second cluster 20B. In some embodiments, each pixel 24 in dual-pixel-driver display 90 is grouped into one first cluster 20A or one second cluster 20B, where the first cluster 20A and the second cluster 20B comprise mutually exclusive groups of pixels.

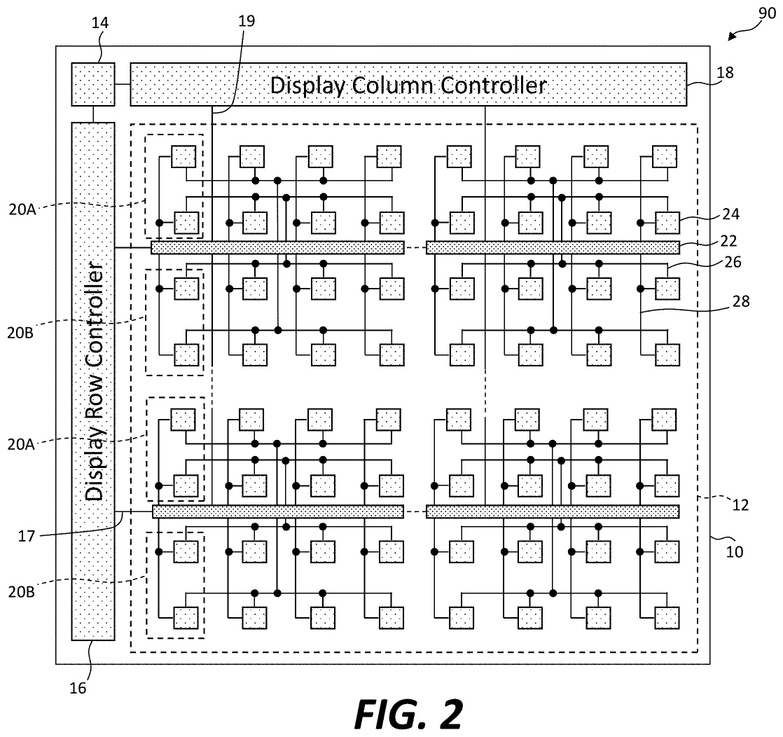

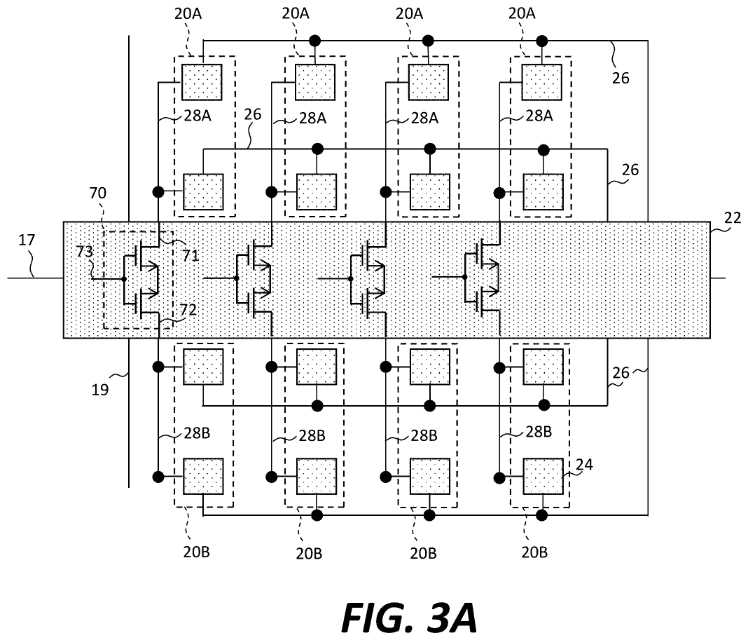

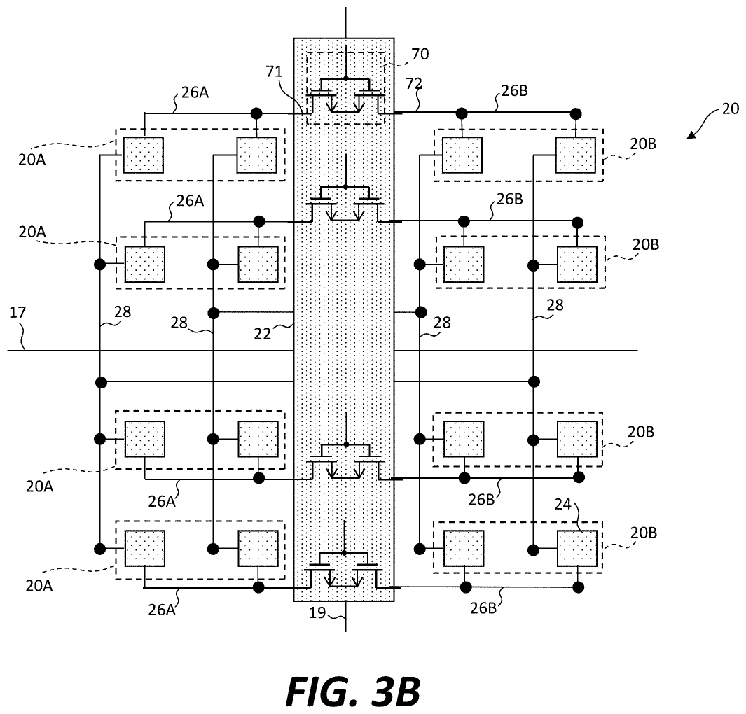

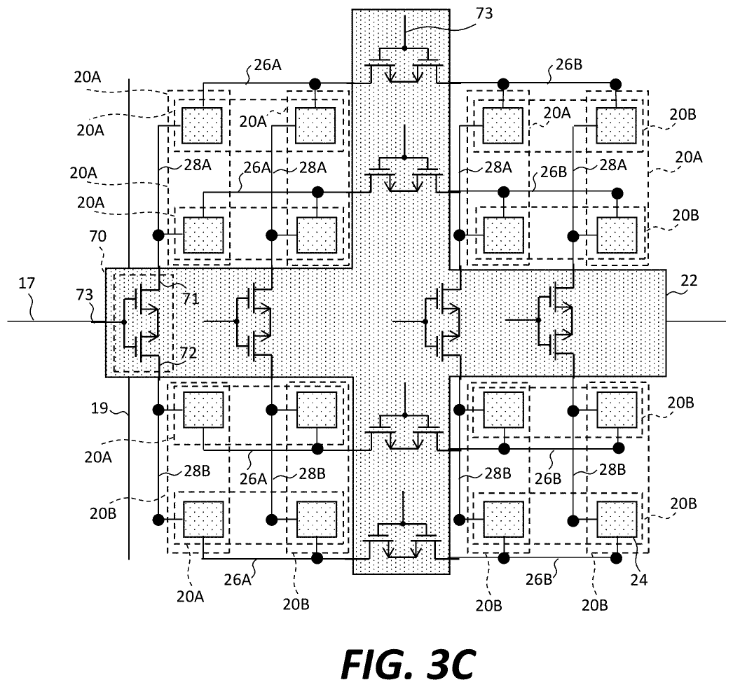

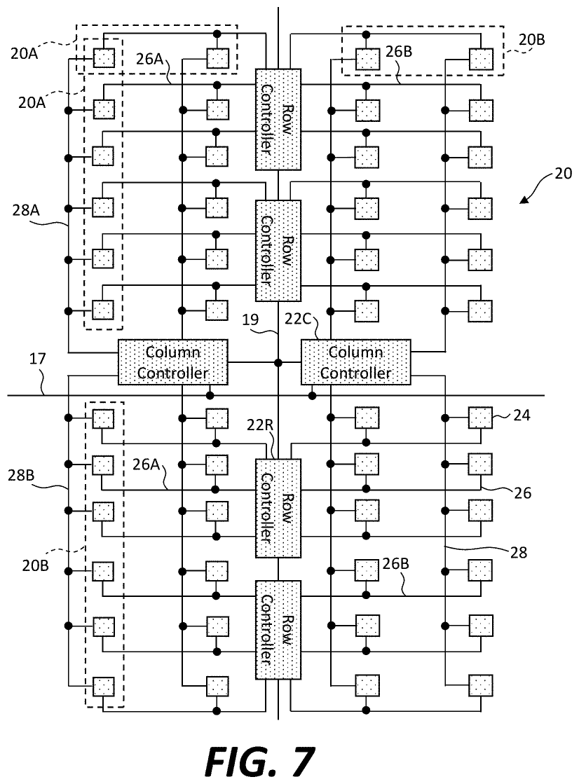

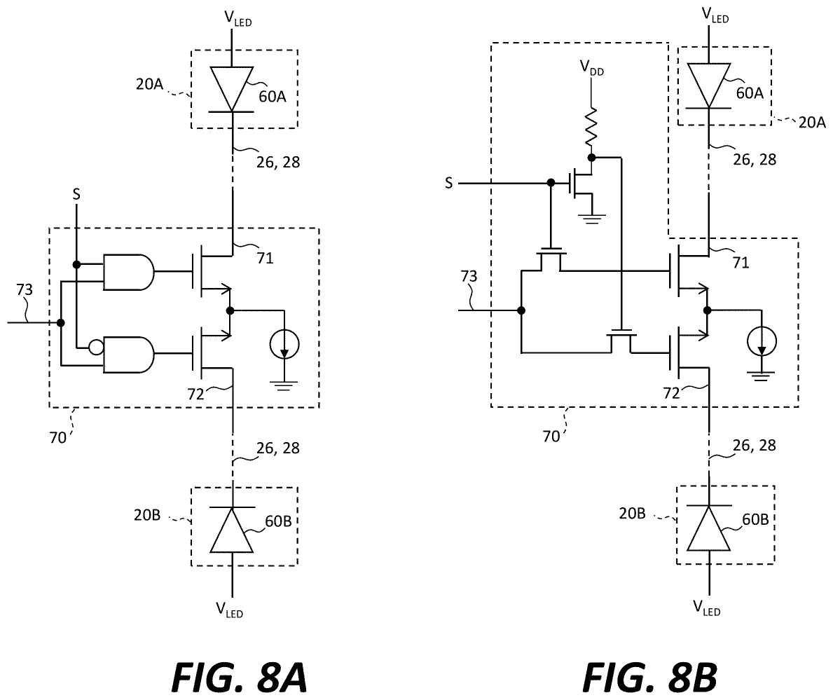

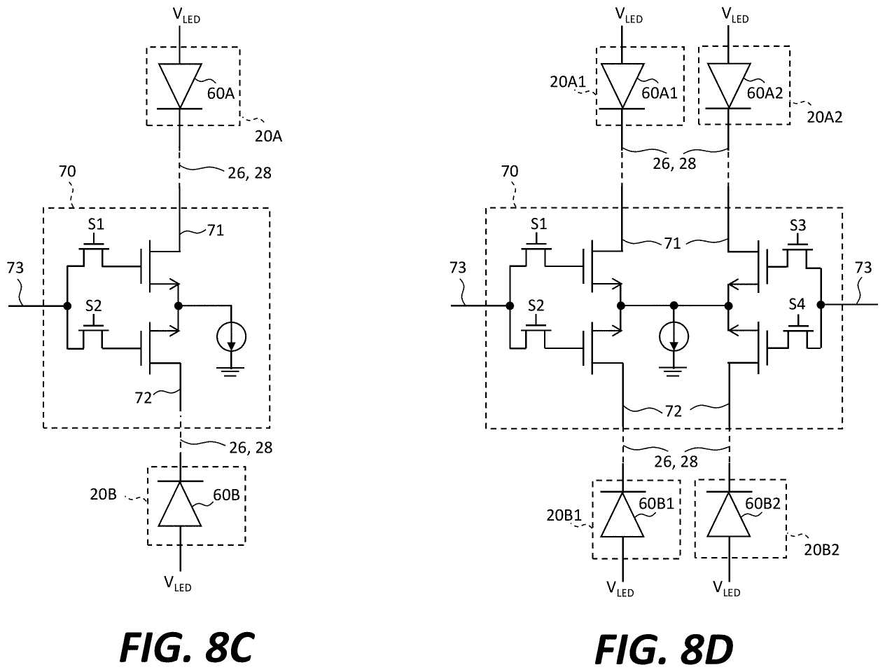

A dual-pixel driver 70 is disposed within display area 12. A cluster controller 22 can comprise one or more dual-pixel drivers 70. As shown in FIG. 2, dual-pixel-driver display 90 can comprise multiple cluster controllers 22. Each dual-pixel driver 70 comprises a driver input 73, a first driver output 71, and a second driver output 72, for example as shown in FIG. 3 and in more detail in FIG. 8. Driver input 73 can comprise one or more signals or wires (e.g., inputs). First driver output 71 is separate from second driver 72, e.g., first driver output 71 is not directly electrically connected to second driver output 72. First driver output 71 and second driver output 72 are both commonly responsive to driver input 73 through a dual-pixel driver 70 circuit so that a change caused by a signal provided through driver input 73 causes a similar response in both first driver output 71 and second driver output 72. First driver output 71 drives pixels 24 in first pixel cluster 20A with a first driver output signal and second driver output 72 drives pixels 24 in second pixel cluster 20B with a second driver output signal. Thus, the signals driven from first and second driver outputs 71, 72 to first and second pixel clusters 20A, 20B can be similar or identical and can be, for example, timing signals or drive signals that enable pixels 24 to operate, for example to emit light. Dual-pixel drivers 70 are therefore also, in some embodiments, dual-cluster drivers 70 that drive all of pixels 24 in each of at least first and second pixel clusters 20A, 20B with similar, but separate signals.

As shown in FIGS. 1 and 3A, first and second pixel clusters 20A, 20B can together comprise each pixel 24 in a column of pixels 24 in the array of pixels 24 (as shown in FIGS. 1 and 3A) or first and second pixel clusters 20A, 20B can together comprise each pixel 24 in a row of pixels 24 in the array of pixels 24 (as shown in FIG. 3B), or both (for example, as shown in FIG. 3C). For example, rows of pixels 24 in first pixel cluster 20A can be connected to a common first cluster row wire 26A and rows of pixels 24 in second pixel cluster 20B can be connected to a common second cluster row wire 26B. First cluster row wire 26A is separate from second cluster row wire 26B. Similarly, columns of pixels 24 in first pixel cluster 20A can be connected to a common cluster first column wire 28A and columns of pixels 24 in second pixel cluster 20B can be connected to a common second cluster column wire 28B. First cluster column wire 28A is separate from second cluster column wire 28B. Pixels 24 in both column clusters and row clusters can respond to both row wires 26 and column wires 28. First cluster row wire 26A or first cluster column wire 28A can be directly connected to first driver output 71 and second cluster row wire 26B or second cluster column wire 28B can be directly connected to second driver output 72 (e.g., can be the same wire).

Dual-pixel-driver display 90 can comprise multiple pairs of first and second clusters 20A, 20B and the pairs of first and second clusters 20A, 20B can overlap if driven by separate dual-pixel drivers 70 (for example to drive different signals, such as row-select or column-data signals, to each pixel 24. For example, every column can comprise a first and second cluster 20A and 20B so that there are as many pairs of first and second clusters 20A, 20B as there are columns in the array or every row can comprise a first and second cluster 20A and 20B so that there are as many pairs of first and second clusters 20A, 20B as there are rows in the array, or both, so that there are as many first and second clusters 20A, 20B as the sum of the number of rows and the number of columns in the array.

Each row or column of pixels 24 can comprise more than one pair of first and second pixel clusters 20A, 20B. In some embodiments, one pair of first and second pixel clusters 20A, 20B together comprise a subset, e.g. half, of pixels 24 in a row of pixels 24 or a column of pixels 24, for example as shown in FIG. 2.

According to some embodiments of the present disclosure and as shown in FIG. 2, dual-pixel-driver display 90 comprises multiple cluster controllers 22, each controlling a different subset of pixels 24 disposed in first and second clusters 20A, 20B. A cluster controller 22 can control only one first and one second cluster 20A, 20B or, as shown in FIGS. 1 and 2, a cluster controller 22 can control multiple pairs of first and second clusters 20A, 20B. The dashed display row wires 17 and display column wires 19 indicate that dual-pixel-driver display 90 can comprise any number of cluster controllers 22 not larger than the number of pixels 24 in the array. As shown in FIG. 2, subsets of each row and each column of pixels 24 are each controlled by a separate cluster controller 22 and each subset of pixels 24 comprises first and second pixel clusters 20A, 20B.

As shown in FIGS. 1, 2, and 3A-3C, dual-pixel drivers 70 can be disposed in one or more cluster controllers 22. Cluster controller 22 can be responsive to a display row controller 16 and a display column controller 18 through display row wires 17 and display column wires 19, respectively. Display row controller 16 and display column controller 18 can be responsive to a display controller 14 or can, together, comprise a display controller 14, for example as shown in FIGS. 1 and 2. Display controller 14 can receive image data (e.g., image pixels) from an external source. Display row signals 17 and display column signals 19 can include data signals, row or column select signals, and timing signals (e.g., frame, refresh, or pulse-width modulation signals). Active-matrix control can be provided to cluster controllers 22 by providing image pixel data from display column controller 18 through display column wires 19 in a row of pixel clusters 20 selected by display row controller 16 through display row wires 17. Display row controller 16 and display column controller 18 can provide active-matrix display row signals 17 and display column signals 19, respectively. (Since display row signals are carried on display row wires they are both referred to as signals/wires 17 and since display column signals are carried on display column wires they are both referred to as signals/wires 19.) Cluster controller 22 can comprise circuits for storing information (e.g., memory) and logic for providing suitable cluster row signals 26 on cluster row wires 26 and cluster column signals 28 on cluster column wires 26. Cluster row signals 26 and cluster column signals 28 can be active-matrix signals or passive-matrix signals for controlling pixels 24 in first and second pixel clusters 20A, 20B. (Since cluster row signals are carried on cluster row wires they are both referred to as signals/wires 26 and since cluster column signals are carried on cluster column wires they are both referred to as signals/wires 28). Cluster row signals 26 provided to pixels 24 in first pixel cluster 20A are labeled first cluster row signals 26A and cluster row signals 26 provided to pixels 24 in second pixel cluster 20B are second cluster row signals 26B (collectively cluster row signals or wires 26). Similarly, cluster column signals 28 provided to pixels 24 in first pixel cluster 20A are labeled first cluster column signals 28A and cluster column signals 28 provided to pixels 24 in second pixel cluster 20B are second cluster column signals 28B (collectively cluster column signals or wires 28).

According to some embodiments and as illustrated in FIG. 3A, dual-pixel drivers 70 can each drive a column or column subset of pixels 24 divided into first and second pixel clusters 20A, 20B. According to some embodiments and as illustrated in FIG. 3B, dual-pixel drivers 70 can each drive a row or row subset of pixels 24 divided into first and second pixel clusters 20A, 20B. FIGS. 3A and 3B are identical in logic but illustrate first and second pixel clusters 20A, 20B disposed in columns or rows, respectively. In some embodiments, dual-pixel drivers 70 in a cluster controller 22 control both rows or row subsets of pixels 24 in first and second pixel clusters 20A, 20B and columns or column subsets of pixels 24 in first and second pixel clusters 20A, 20B, as shown in FIG. 3C. Multiple cluster controllers 22 (or, equivalently, cluster controllers 22 comprising multiple integrated circuits) can reduce the size of each cluster controller 22 so that the cluster controllers 22 are more readily disposed between pixels 24 in the array and reduce the length of signal wires (e.g., cluster row wires 26 and cluster column wires 28) in the array to enhance signal integrity.

Cluster controller 22 can be an integrated circuit, e.g., a silicon CMOS integrated circuit with digital or mixed-signal digital and analog circuits. Cluster controller 22 can be an unpackaged bare die, for example micro-transfer printed from a controller source wafer to display substrate 10, and can comprise a separated or broken (e.g., fractured) cluster controller tether 23. Cluster controller 22 can comprise multiple integrated circuits, each with a separated or broken (e.g., fractured) cluster controller tether 23.

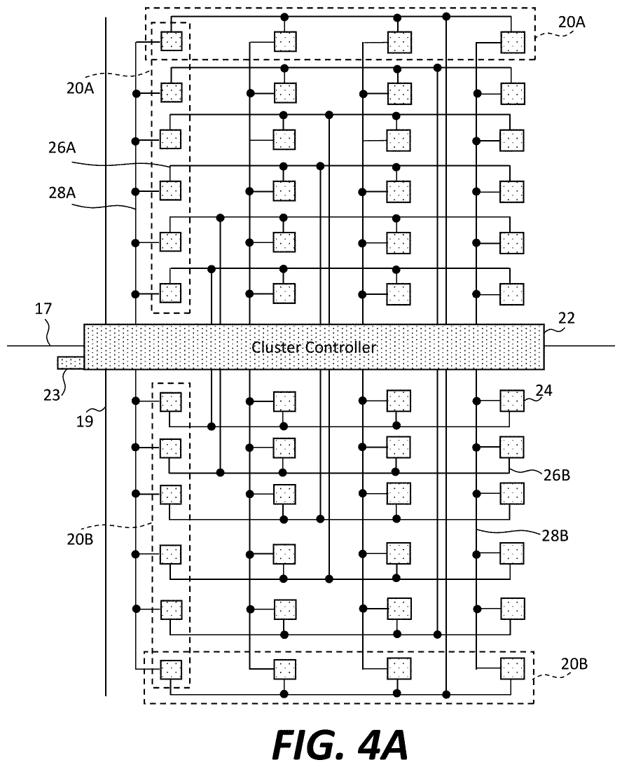

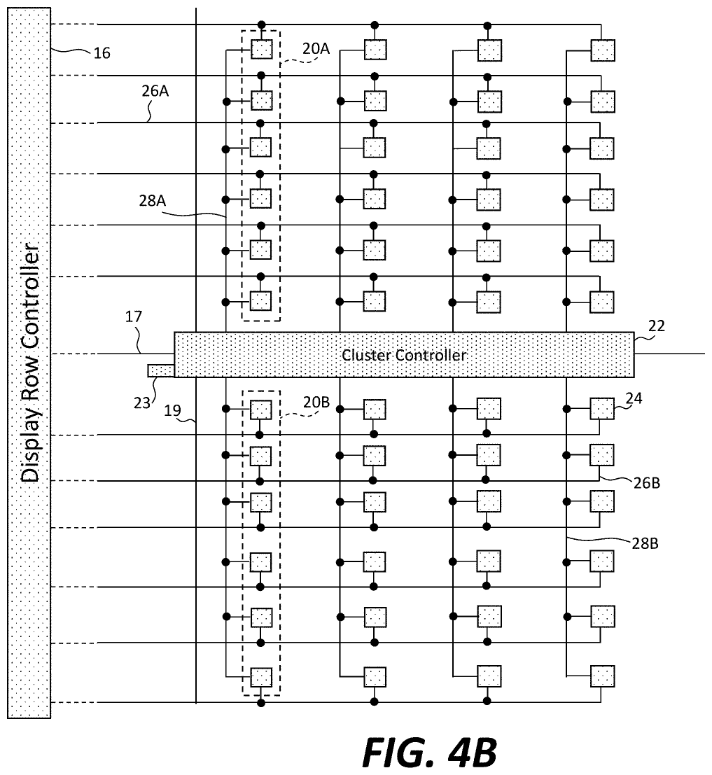

As shown in FIGS. 1-3C, cluster controller 22 comprises a dual-pixel driver 70 for each row (or row subset) of pixels 24 (e.g., as shown in FIGS. 3B, 3C), each column (or column subset) of pixels 24 (e.g., as shown in FIGS. 1, 2, 3A, and 3C), or both (e.g., as shown in FIG. 3C). Embodiments of the present disclosure provide improved signal integrity cluster signal wires (e.g., cluster row wires 26 and cluster column wires 28) connected to pixels 24. By providing pixels 24 in first and second pixel clusters 20A, 20B with separate signal wires (e.g., cluster row wire 26 and cluster column wire 28) driven with separate driver output signals (e.g., signals on first driver output 71 and second driver output 72), the length of the wires can be reduced by up to half and any parasitic capacitance or inductance in the wires or in pixel 24 inputs connected to the wires is likewise reduced by half, improving the integrity of signals provided on the wires and reducing the power needed to drive the signals on the wires. (Further reduction may be achieved using more than one pair of first and second pixel clusters 20A, 20B in each row and/or column, as discussed further below.) This is particularly true for first and second pixel clusters 20A, 20B comprising a large number of pixels 24, for example as shown in FIG. 4A. FIG. 4A illustrates embodiments in which cluster controller 22 provides both cluster row signals 26 and cluster column signals 28. In some embodiments, cluster controller 22 provides on cluster row signals 26 or cluster column signals 28, but not both. FIG. 4B illustrates embodiments in which cluster controller 22 provides cluster column signals 28 but display row controller 16 provides cluster row signals 26. In some embodiments, not illustrated, cluster controller 22 provides cluster row signals 26 but display column controller 18 provides cluster column signals 28.

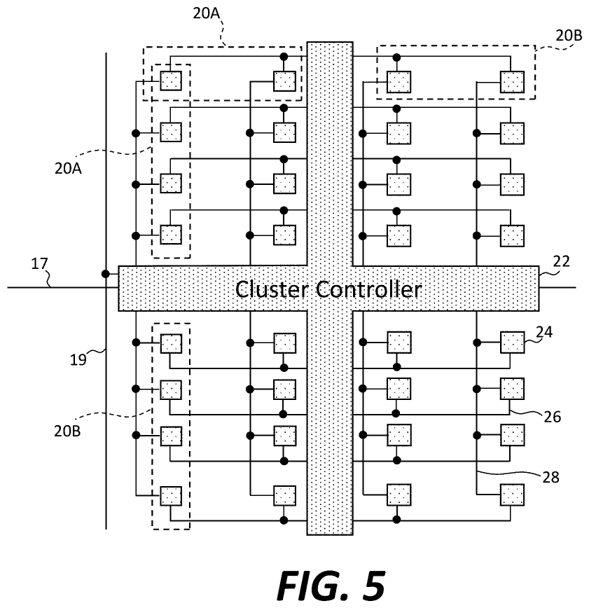

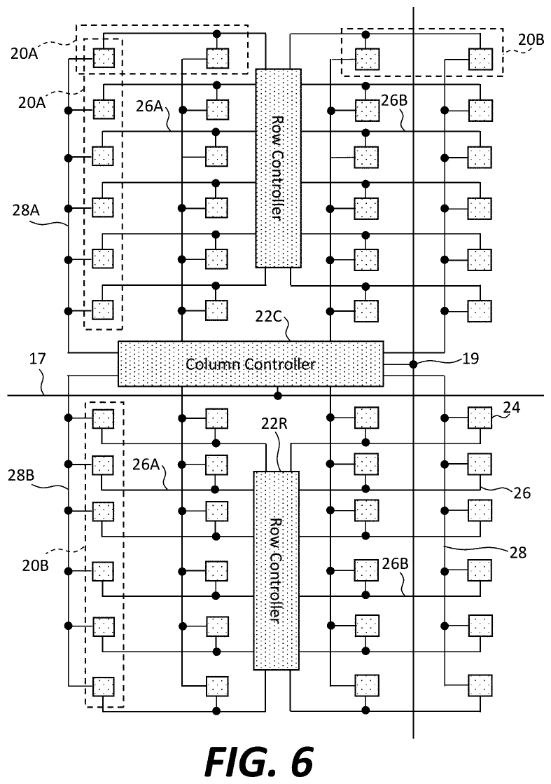

Wire length can be further reduced by providing cluster controllers 22 that have a ‘+’ (plus or cross) shape, as shown in FIG. 5, so that portions of cluster controller 22 are physically and spatially closer to rows of pixels 24 and portions of cluster controller 22 are closer to columns of pixels 24. Wire length can also be reduced by providing multiple cluster controllers 22, as illustrated in FIG. 2. According to some embodiments, dual-pixel-driver display 90 comprises a separate cluster controller 22 for each of rows and columns of pixels 24 in the array. As illustrated in FIG. 6, column cluster controller 22C provides first and second cluster column signals 28A, 28B to first and second pixel clusters 20A, 20B, respectively, comprising columns of pixels 24 and cluster row controller 22R provides first and second cluster row signals 26A, 26B to first and second pixel clusters 20A, 20B, respectively, comprising rows of pixels 24. Each of cluster row controllers 22R and cluster column controller 22C can be implemented with multiple cluster row and column controllers 22R, 22C, respectively, as shown in FIG. 7. By providing multiple cluster controllers, the length of cluster row wires 26 and cluster column wires 28 can be reduced, for example by half. In some embodiments, cluster row controllers 22R and cluster column controllers 22C are disposed at or near the center of rows or columns of pixels 24 in the subarray of pixels 24 in first and second pixel clusters 20A, 20B controlled by the cluster row or column controller 22R, 22C, respectively. First and second pixel clusters 20A, 20B can comprise an equal number of pixels 24. Multiple row and column cluster controllers 22R, 22C can be electrically connected to coordinate timing and control of the various clusters 20. Cluster row controllers 22R and cluster column controllers 22C are collectively cluster controllers 22.

Dual-pixel drivers 70 can comprise transistors, for example two transistors, with a common driver input 73 connection to the transistor gates. As shown in FIGS. 3A-3C and FIGS. 8A-8C, a dual-pixel driver 70 can comprise two transistors with sources connected in common to a current sink. The drain of each transistor is connected to an LED 60, for example a first LED 60A in a first pixel cluster 20A and a second LED 60B in a second pixel cluster 20B. Although only a single LED 60 is shown in each pixel cluster 20 in FIGS. 8A-8C, embodiments of the present disclosure comprise multiple LEDs 60 (or pixels 24) in each pixel cluster 20 for example as shown in FIGS. 1-7. The gates of the transistors can be directly connected together, as shown in FIGS. 3A-3C, and driven by a driver input 73 signal, for example a timing signal such as a pulse-width modulation (PWM) signal. In this way, the driving transistors can be temporally controlled and provide a constant current in a passive-matrix configuration, improving the efficiency of dual-pixel-driver display 90, since LEDs 60 can be most efficient at a particular current. In some embodiments of an active-matrix configuration, a signal on first driver output 71 can be a row-select or a signal on first driver output 71 can be column-data signal provided by driver input 73.

By providing a dual-pixel drive 70 circuit for controlling rows or columns of pixels 24, separate signals (e.g., signals on first and second driver outputs 71, 72) are provided to subsets of pixels 24 in rows or columns of pixels 24 (e.g., first and second pixel clusters 20A, 20B), thus reducing the resistance, inductance, and capacitance of the wires (e.g., the RC time constant of cluster row wires 26 and cluster column wires 28) in each pixel cluster 20. Because signals on first and second driver outputs 71, 72 are provided separately to first and second pixel clusters 20A, 20B, they can also be controlled separately, as shown in FIGS. 8A-8C. For example, first cluster row signal 26A or first cluster column signal 28A can be provided while second cluster row signal 26A or second cluster column signal 28B is not. In conventional active- or passive-matrix designs, column data signals are sent to every pixel 24 in a column, even though it is only received by pixels 24 in a selected row. In contrast, embodiments of the present disclosure can send a row-select or column-data signal to pixels 24 in only one of first and second pixel clusters 20A, 20B, reducing the power used and the RC time constant of the signals.

FIGS. 8A-8C illustrate more-complex dual-pixel driver 70 circuits with separate control of each of first and second driver outputs 71, 72. FIG. 8A shows a logical circuit comprising an AND circuit connected to each of the transistor gates. When driver input 73 signal (e.g., a PWM timing signal) is high and switch S is high, first LED 60A in first pixel cluster 20A can emit light. When driver input 73 signal (e.g., a PWM timing signal) is high and switch S is low, second LED 60B in second pixel cluster 20B can emit light. FIG. 8B illustrates the same circuit with transistor connections. FIG. 8C illustrates an embodiment in which two separate switches, S1 and S2 separately enable the two transistors so that each can be controlled separately, allowing both transistors to be turned off or both transistors to be turned on at the same time. If both transistors are turned off, for example if the corresponding pixels 24 are dark, leakage through the transistors is reduced and power efficiency is improved.

According to embodiments of the present disclosure and as shown in FIG. 8D, dual-pixel driver 70 can drive more than one pair of first and second pixel clusters 20A, 20B, for example two, three, or four pairs of first and second pixel clusters 20A, 20B. Pixels 24 in the pairs of first and second pixel clusters 20A, 20B can be in a common column or row of the array of pixels 24. As shown in FIG. 8D, LEDs 60 in a first pixel cluster 20A1 of a first pair of clusters 20 are labeled 60A1 and LEDs 60 in a first pixel cluster 20A2 of a second pair of clusters 20 are labeled 60A2. Similarly, LEDs 60 in a second pixel cluster 20B1 of a first pair of clusters 20 are labeled 60B1 and LEDs 60 in a second pixel cluster 20B2 of a second pair of clusters 20 are labeled 60B2. If pixels 24 in first and second pairs of clusters 20 are in a common column (or row), then one pixel cluster 20 (e.g., pixel cluster 20A2) can be further from dual-pixel driver 70 over display area 12 than another pixel cluster 20 (e.g., pixel cluster 20A1) so that one cluster wire (e.g., row cluster wire 26 or column cluster wire 28 connected to pixel cluster 20A2) can have a longer length and therefore greater resistance than another cluster wire (e.g., row cluster wire 26 or column cluster wire 28 connected to pixel cluster 20A1). Each of the cluster wires (e.g., row cluster wire 26 or column cluster wire 28) can be independently controlled with switches (e.g., S1, S2, S3, S4 as shown in FIG. 8D) or mutually exclusively (as illustrated in FIGS. 8A-8B), or in common (not shown in the Figures). Despite the additional resistance of one of the cluster wires with a longer length than another of the cluster wires, the number of pixels 24 (or LEDs 60) connected to each of the cluster wires can be reduced by up to half, thereby reducing the input impedance on each cluster wire by a similar amount (e.g., due to components in pixels 24 such as LEDs 60 or pixel controllers 30), so that higher frequency signals can be driven by dual-pixel drivers 70 on cluster wires with reduced power, increasing the potential frame rate and reducing the power used by dual-pixel-driver display 90.

Driver input 73 can comprise multiple signals, for example comprising the signals S, S1, S2, S3, S4 controlling the enable switches as well as the timing signal labeled 73 as shown in FIGS. 8A-8D.

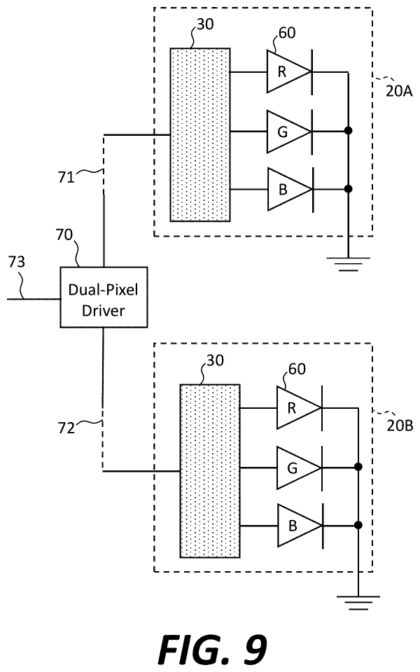

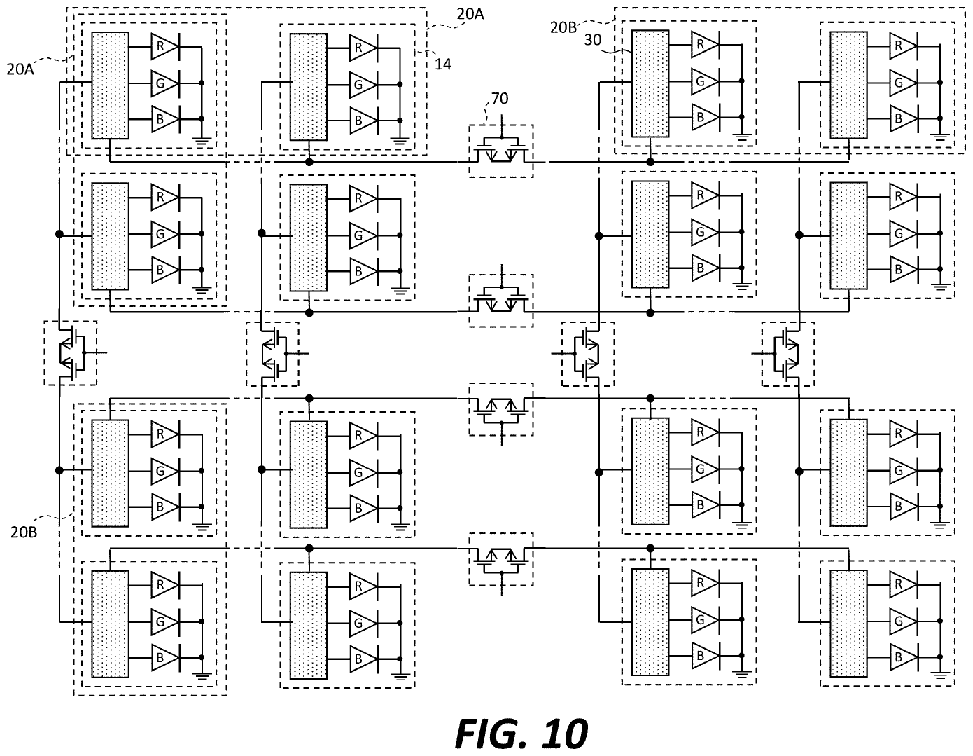

According to some embodiments of the present disclosure, cluster controller 22 directly controls light emitters 60 such as LEDs 60 with passive-matrix control signals, for example as illustrated in FIGS. 8A-8C. In some embodiments and as shown in FIG. 9, cluster controller 22 can provide active-matrix signals (e.g., row-select and column-data signals) to a pixel controller 30 circuit that, in turn drives LED(s) 60 to emit light in response to the received driver input 73 active-matrix signals. In FIGS. 8A-9, the dashed control lines (e.g., in first and second driver outputs 71, 72) indicate that the respective control lines are connected to one or more pixels 24 (or LEDs 60) in a first or second pixel cluster 20A, 20B. FIG. 10 illustrates embodiments with dual-pixel drivers 70 for both first and second row and column clusters 20A, 20B, for example as in FIG. 3C and FIG. 7.

Pixel clusters 20 and pixels 24 can be disposed on or over a display substrate 10, for example a glass or polymer substrate, within a display area 12 comprising all of pixels 24 and at least some of cluster controllers 22. Display area 12 can be, for example, a convex hull comprising pixels 24. Thus, at least a portion or all of cluster controllers 22 are disposed between pixels 24 on display substrate 10 in display area 12. In contrast, display row controller 16, display column controller 18, and display controller 14 can be disposed on display substrate 10 external to display area 12, for example adjacent to the edges or sides of display area 12. Display row controller 16, display column controller 18, and display controller 14 can be packaged integrated circuits mounted on display substrate 10.

According to embodiments of the present disclosure, pixels 24 of pixel clusters 20 can comprise one or more light emitters 60, for example micro-light-emitting diodes 60 that each emit different colors of light, for example red LEDs that emit red light, green LEDs that emit green light, and blue LEDs that emit blue light when provided with enough current at a suitable voltage. Cluster row signals 26 (e.g., cluster row-select signals) and cluster column signals 28 (e.g., cluster column-data signals) can provide enough current at suitable voltages to drive each of LEDs 60 in each pixel 24 or a pixel controller 30. Display or cluster row signals 16, 26 and display column controller 18 or cluster column signals 28 can comprise one or more of row-select, timing, column-data signals, or current-select signals 40 but are not limited to such and can implement any suitable control and data function desired.

Pixels 24 can comprise light emitters 60, for example light-emitting diodes 60, for example inorganic light-emitting diodes 60, for example micro-light emitting diodes 60 having a length or width no greater than one hundred microns, for example no greater than fifty microns, no greater than twenty microns, no greater than fifteen microns, no greater than twelve microns, or no greater than ten microns, and a thickness no greater than fifty microns, for example no greater than twenty microns, no greater than ten microns, or no greater than five microns. Micro-light-emitting diodes 60 can be bare, unpackaged die, for example integrated circuit die, and can be micro-transfer printed from a micro-light-emitting diode source wafer to display substrate 10 and can comprise a fractured or separated LED tether 61 as a consequence of micro-transfer printing.

According to some embodiments of the present disclosure, cluster controllers 22 can likewise be unpackaged bare die, for example integrated circuit die, and can be micro-transfer printed from a cluster controller source wafer to display substrate 10 or other substrate and can comprise a broken (e.g., fractured) or separated cluster controller tether 23 as a consequence of micro-transfer printing. Cluster controller 22 can comprise one or more integrated circuits, for example unpackaged, micro-transfer printed, bare die disposed at least partly or completely between pixels 24 providing cluster controller 22, cluster row controller 22R, or cluster column controller 22C to enable passive- or active-matrix control of pixels 24. Cluster controllers 22 can have a length or width, or both, no greater than two hundred microns, for example no greater than one hundred microns, no greater than fifty microns or no greater than twenty microns, and, alternatively or additionally, a thickness no greater than fifty microns, for example no greater than twenty microns, no greater than ten microns, or no greater than five microns. Micro-transfer printed integrated circuits, for example micro-LEDs 60, are relatively small and can therefore be provided at a high density and resolution on display substrate 10. Likewise, cluster controllers 22 can be very small and can therefore be provided between pixels 24 in display area 12 on or over display substrate 10.

According to embodiments of the present disclosure, LEDs 60 emit light most efficiently at a particular current. This efficient current can be different for different LEDs 60, for example LEDs 60 made with different materials or that emit different colors of light. It is useful, therefore, to operate LEDs 60 at their most efficient current to provide a power-efficient display and to select different efficient currents for different corresponding types of LEDs 60.

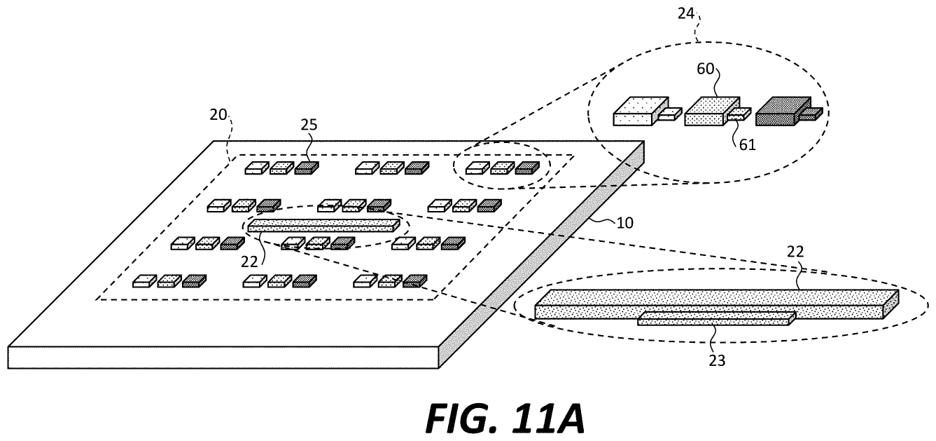

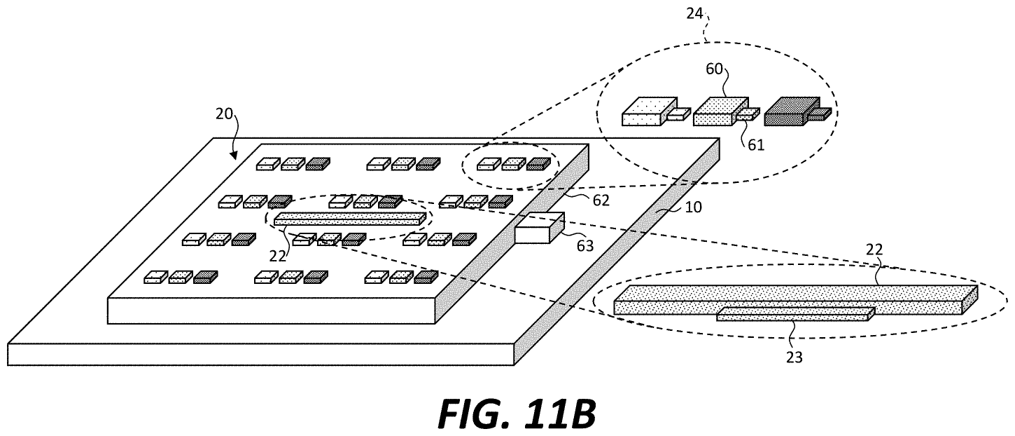

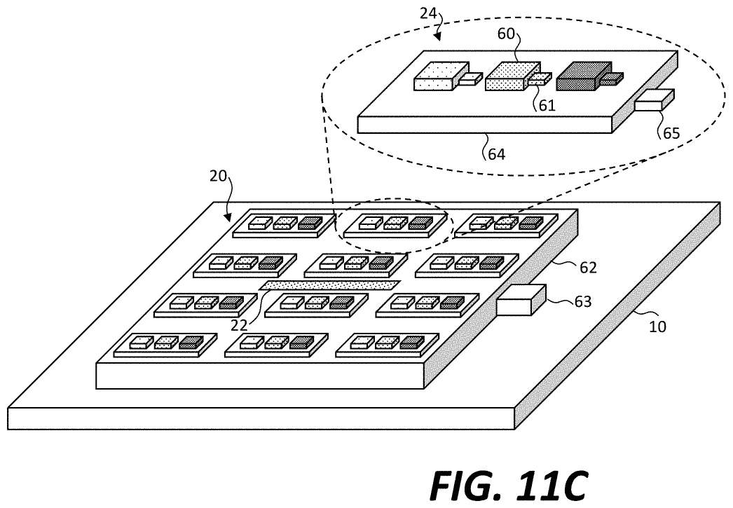

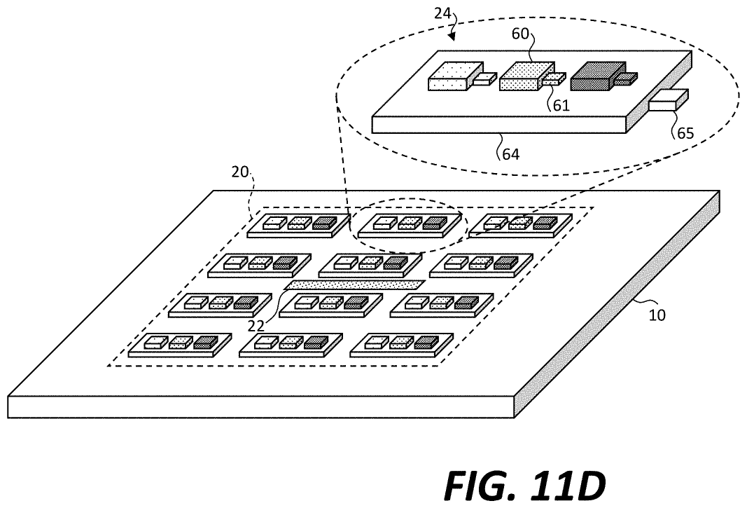

A dual-pixel-driver display 90 according to embodiments of the present disclosure can comprise light-emitting diodes (LEDs) 60 made with compound semiconductor materials and LED substrates separate, distinct, and individual from display substrate 10. As shown in FIG. 11A, each LED 60 can comprise a broken (e.g., fractured) or separated LED tether 61 fractured or separated as a consequence of micro-transfer printing LEDs 60 from an LED source wafer (e.g., a compound semiconductor substrate such as GaN or GaAs) to display substrate 10. Similarly, cluster controller 22 can comprise a fractured or separated cluster controller tether 23 fractured or separated as a consequence of micro-transfer printing cluster controller 22 from a cluster-controller source wafer (e.g., a semiconductor substrate such as silicon) to display substrate 10. Thus, in some embodiments LEDs 60 and cluster controller 22 are disposed directly on display substrate 10 or directly on layers disposed on display substrate 10. FIG. 11A illustrates one pixel cluster 20 disposed on display substrate 10 but dual-pixel-driver displays 90 of the present disclosure can comprise multiple pixel clusters 20 disposed on display substrate 10, for example an array of pixel clusters 20 defining a display area 12 as shown in FIG. 1.

In some embodiments, LEDs 60 and pixel controller 30 are disposed directly on display substrate 10, as shown in FIG. 11A. In some embodiments, and as illustrated in FIG. 11B, LEDs 60 and cluster controller 22 are micro-transfer printed onto a cluster substrate 62 that is separate, individual, and distinct from display substrate 10 and separate, individual, and distinct from LEDs 60 and any LED substrates and cluster controller 22 substrate. LEDs 60 and a cluster controller 22 of one or more pixel clusters 20 (e.g., first and second pixel clusters 20A, 20B) can be disposed on cluster substrate 62. A single pixel cluster 20 can be disposed on a single cluster substrate 62 or multiple pixel clusters 20 can be disposed on a single cluster substrate 62. Cluster substrates 62 can be disposed on display substrate 10, for example by micro-transfer printing or other assembly processes, such as surface-mount technology. Pixel clusters 20 on cluster substrates 62 can be surface-mount devices or can be micro-assembled, for example by micro-transfer printing cluster substrates 62 from a cluster source wafer to display substrate 10 so that cluster substrates 62 can comprise a broken (e.g., fractured) or separated cluster tether 63 as a consequence of micro-transfer printing. Cluster substrates 62 can comprise a same material as display substrate 10 or can be a different material.

According to some embodiments and as shown in FIGS. 11C-11D, LEDs 60 and pixel controller 30 can be disposed on a pixel substrate 64 and LEDs 60 and pixel controller 30 can be micro-transfer printed from respective source wafers to pixel substrate 64 so that LEDs 60 comprise an LED tether 61 and pixel controller 30 comprises a pixel controller tether 31. In some embodiments, pixel substrate 64 is a semiconductor substrate and pixel controller 30 is native to pixel substrate 64. In some embodiments, pixel substrate 64 is micro-transfer printed from a pixel source wafer to a cluster substrate 62 and can comprise a pixel tether 65. (Pixel controller 30 is not illustrated in FIGS. 11A-11D but is shown in FIG. 9.)

As illustrated in FIG. 11C, cluster controller 22 in each pixel cluster 20 can be formed in or on and native to cluster substrate 62 rather than micro-assembled on cluster substrate 62, for example where cluster substrate 62 is a semiconductor substrate such as a silicon substrate and by using photolithographic processes found in the integrated circuit industry. Cluster controller 22 can be an integrated circuit. As also illustrated in FIG. 11C, pixels 24 with LEDs 60 can be micro-assembled on a pixel substrate 64 and pixel substrate 64 can be micro-assembled on cluster substrate 62 so that pixel substrate 64 can comprise a broken (e.g., fractured) or separated pixel tether 65 as a consequence of micro-assembling pixel substrate 64 from a pixel source wafer to cluster substrate 62. Pixel substrates 64 can comprise material similar to or the same as cluster substrate 62 or display substrate 10. One or more pixels 24 with pixel substrates 64 can be disposed directly on cluster controller 22, where cluster controller 22 is native to cluster substrate 62, so that cluster controller 22 can occupy a substantial amount of space on cluster substrate 62 or cluster controller 22 can be disposed between pixels 24 (as shown in FIG. 11C) where cluster controller 22 is non-native to cluster substrate 62. Cluster substrate 62 can be assembled on display substrate 10 or layers on display substrate 10, e.g., by using surface-mount techniques or micro-assembly using, for example, micro-transfer printing.

According to some embodiments and as shown in FIG. 11D, cluster controller 22 can be formed in or on and native to display substrate 10, for example where display substrate 10 is a semiconductor substrate, e.g., with photolithographic processing and materials, for example a silicon substrate in a micro-display. LEDs 60 in pixels 24 can be assembled, for example by micro-transfer printing, directly on display substrate 10 or layers on display substrate 10, as shown in FIG. 11A, or can be disposed on pixel substrates 64 and pixel substrates 64 can be assembled, for example by micro-transfer printing, onto display substrate 10 or layers disposed on display substrate 10, as shown in FIG. 11D.

Embodiments of the present disclosure illustrate in FIGS. 11B-11D use cluster substrates 62 or pixel substrates 64, or both, to provide a compound micro-assembled structure. Such structures can be tested before assembly on display substrate 10. For example, pixel clusters 20 on cluster substrates 62 as shown in FIGS. 11B and 11C can be tested before assembly on display substrate 10. Similarly, pixels 24 disposed on pixel substrates 64 can be tested before micro-assembly on cluster substrates 62 or display substrate 10. By testing pixel clusters 20 or pixels 24 before assembly, any defective cluster controllers 22 or pixels 24 can be discarded and not assembled on display substrate 10 or cluster substrate 62, thereby improving dual-pixel-driver display 90 yields and reducing costs. For example, either or both cluster substrate 62 or pixel substrate 64 can comprise probe pads for automated testing and micro-assembly systems can be programmed to discard or not assemble any defective pixel clusters 20 or defective pixels 24.

Display substrates 10 of large-format displays can have signal-carrying wires (e.g., display row wires 17 and display column wires 19) that are lengthy (e.g., greater than one meter). Such long wires have a finite resistance and can experience parasitic capacitance and therefore signals carried on the wires can degrade significantly over the extent of display substrate 10. FIG. 1 illustrates display row wires 17 and display column wires 19 directly connected to each pixel cluster 20 and cluster controller 22 in an array of pixel clusters 20 disposed over display substrate 10. According to some embodiments, electrically connecting display row wires 17 and display column wires 19 to fewer devices (e.g., a few cluster controllers 22 rather than many pixels 24) reduces the RC time constant of display row wires 17 and display column wires 19 and increases their data rate. Similarly, electrically connecting cluster row wires 26 and cluster column wires 28 to fewer pixels 24 that are closer together using dual-pixel drivers 70 reduces the RC time constant of cluster row wires 26 and cluster column wires 28 and increases their data rate. Furthermore, signals on display row wires 17 and display column wires 19 can be regenerated over display substrate 10, for example in cluster controllers 22, to improve their integrity.

Display substrate 10 can be any useful substrate on which cluster controllers 22 and an array of pixels 24 can be suitably disposed, for example glass, plastic, resin, fiberglass, semiconductor, ceramic, quartz, sapphire, or other substrates found in the display or integrated circuit industries. Display substrate 10 can be flexible or rigid and can be substantially flat and have relatively parallel opposing sides. Display row wires 17 and display column wires 19 can be wires (e.g., photolithographically defined electrical conductors such as metal lines) disposed on display substrate 10 that conduct electrical current from display row controllers 16 and display column controllers 18, respectively, to cluster controllers 22. Similarly, cluster row wires 26 and cluster column wires 28 can be wires (e.g., photolithographically defined electrical conductors such as metal lines) disposed on display substrate 10 that conduct electrical current from cluster controllers 22 to pixels 24 and LEDs 60.

Generally, display substrate 10, cluster substrate 62, and pixel substrate 64, if present, each have two opposing smooth sides suitable for material deposition, photolithographic processing, or micro-transfer printing of micro-LEDs 60 or cluster controllers 22 and can comprise similar materials. Display substrate 10 can have a size of a conventional display, for example a rectangle with a diagonal of a few centimeters to one or more meters. Display substrate 10 can include polymer, plastic, resin, polyimide, PEN, PET, metal, metal foil, glass, a semiconductor, or sapphire and have a transparency greater than or equal to 50%, 80%, 90%, or 95% for visible light. In some embodiments of the present disclosure, LEDs 60 emit light through display substrate 10. In some embodiments, LEDs 60 emit light in a direction opposite display substrate 10. Display substrate 10 can have a thickness from 5 microns to 20 mm (e.g., 5 to 10 microns, 10 to 50 microns, 50 to 100 microns, 100 to 200 microns, 200 to 500 microns, 500 microns to 0.5 mm, 0.5 to 1 mm, 1 mm to 5 mm, 5 mm to 10 mm, or 10 mm to 20 mm). According to some embodiments of the present disclosure, display substrate 10 can include layers formed on an underlying structure or substrate, for example a rigid or flexible glass or plastic substrate.

In some embodiments, display substrate 10 can have a single, connected, contiguous display area 12 (e.g., a convex hull including pixels 24 that each have a pixel functional area such as the light-emitting area of LEDs 60 in pixels 24). The combined functional area of light emitters 60 can be less than or equal to one-quarter of display area 12. In some embodiments, the combined functional areas of light emitters 60 is less than or equal to one eighth, one tenth, one twentieth, one fiftieth, one hundredth, one five-hundredth, one thousandth, one two-thousandth, or one ten-thousandth of the contiguous system substrate area. Thus, remaining area over display substrate 10 is available for additional functional elements such as cluster controllers 22 or pixel controllers 30.

Cluster controller 22, cluster row controller 22R, cluster column controller 22C, or pixel controllers 30 can each be, for example, a bare, unpackaged integrated circuit die disposed between rows and columns of pixels 24 that provides control, timing (e.g., clocks) or data signals (e.g., column-data signals) through cluster row wires 26 and cluster control wires 28 to pixels 24 to enable pixels 24 to emit or control light in dual-pixel-driver display 90.

The array of pixels 24 can be a completely regular array (e.g., as shown in FIG. 1) or can have pixel rows or pixel columns of pixels 24 that are offset from each other, so that pixel rows or pixel columns of pixels 24 are not disposed in a straight line and can, for example, form a zigzag line (not shown in the Figures) or, as another example, have non-uniform spacing(s).

Pixels 24 can be passive-matrix pixels 24, can be analog or digital, and can comprise one or more light-controlling or light-responsive elements, e.g., inorganic micro-light-emitting diodes 60. Pixels 24 can comprise micro-light-emitting diodes 60. Inorganic light-emitting diodes 60 can have a small area, for example having a length and a width each no greater than 20 microns, no greater than 50 microns, no greater than 100 microns, or no greater than 200 microns. Such small, light emitters 60 leave additional area on display substrate 10 for more or larger wires or additional functional elements such as cluster controllers 22. When active, pixels 24 can be controlled at a constant current with timing signals 42 such as temporal pulse-width modulation signals provided by cluster controller 22 or pixel controller 30. Pixels 24 can comprise a red-light-emitting diode 60 that emits red light, a green-light-emitting diode 60 that emits green light, and a blue-light-emitting diode 60 that emits blue light (collectively light-emitting diodes 60 or LEDs 60) under the control of cluster controller 22. In certain embodiments, light emitters 60 that emit light of other color(s) are included in pixel 24, such as a yellow light-emitting diode 60. Light-emitting diodes 60 can be mini-LEDs 60 (e.g., having a largest dimension no greater than 500 microns) or micro-LEDs 60 (e.g., having a largest dimension of no greater than 100 microns). Pixels 24 can emit one color of light or white light (e.g., as in a black-and-white display) or multiple colors of light (e.g., red, green, and blue light as in a color display).

According to some embodiments of the present disclosure, pixels 24 comprise inorganic micro-light-emitting diodes 60 that have a length and a width over display substrate 10 or pixel substrate 64 that is no greater than 100 microns (e.g., no greater than 50 microns, no greater than 20 microns, no greater than 15 microns, no greater than 12 microns, no greater than 10 microns, no greater than 8 microns, no greater than 5 microns, or no greater than 3 microns). Such relatively small, light emitters 60 disposed on a relatively large display substrate 10 (for example a laptop display, a monitor display, or a television display) take up relatively little area on display substrate 10 so that the fill factor of LEDs 60 on display substrate 10 (e.g., the aperture ratio or the ratio of the sum of the areas of LEDs 60 over display substrate 10 to the convex hull area of display substrate 10 that includes LEDs 60 or minimum rectangular area of the array of pixels 24 such as display area 12) is no greater than 30% (e.g., no greater than 20%, no greater than 10%, no greater than 5%, no greater than 1%, no greater than 0.5%, no greater than 0.1%, no greater than 0.05%, or no greater than 0.01%). For example, an 8K display (having a display array 12 bounding 8192 by 4096 display pixels 24) over a 2-meter diagonal 9:16 display with micro-LEDs 60 having a 15-micron length and 8-micron width has a fill factor of much less than 1%. An 8K display having 40-micron by 40-micron pixels 24 can have a fill factor of about 3%. According to some embodiments of the present disclosure, the remaining area not occupied by light emitters 60 is used at least partly to provide cluster controllers 22 between light emitters 60.

In contrast to embodiments of the present disclosure, existing prior-art flat-panel displays have a desirably large fill factor. For example, the lifetime of OLED displays is increased with a larger fill factor because such a larger fill factor reduces current density and improves organic material lifetimes. Similarly, liquid-crystal displays (LCDs) have a desirably large fill factor to reduce the necessary brightness of the backlight (because larger pixels transmit more light), improving the backlight lifetime and display power efficiency. Thus, prior displays cannot provide integrated cluster control because there is no space on their display substrates for additional or larger functional elements, such as cluster controllers 22, in contrast to embodiments of the present disclosure.

In some embodiments, integrated circuits such as LEDs 60 or cluster controllers 22 are made in or on a native semiconductor wafer and have a semiconductor substrate and are micro-transfer printed to a non-native substrate, such as pixel substrate 64, cluster substrate 62, or display substrate 10. Any of pixel substrate 64, cluster substrate 62, and display substrate 10 can include glass, resin, polymer, plastic, ceramic, or metal and can be non-elastomeric. Cluster substrate 62 can be a semiconductor substrate and cluster controller 22 can be formed in or on and native to cluster substrate 62. Semiconductor materials (for example doped or undoped silicon, GaAs, or GaN) and processes for making small integrated circuits are well known in the integrated circuit arts. Likewise, backplanes such as display substrates 10 and means for interconnecting integrated circuit elements on the backplane are well known in the display and printed circuit board arts.

In a method according to some embodiments of the present disclosure, integrated circuits are disposed on the display substrate 10 by micro transfer printing. In some methods, integrated circuits (or portions thereof) or LEDs 60 are disposed on pixel substrate 64 to form a heterogeneous pixel 24 and pixel 24 is disposed on cluster substrate 62 or display substrate 10 using compound micro-assembly structures and methods, for example as described in U.S. patent application Ser. No. 14/822,868 filed Aug. 10, 2015, entitled Compound Micro-Assembly Strategies and Devices. However, since pixels 24 or pixel clusters 20 can be larger than the integrated circuits included therein, in some methods of the present disclosure, pixels 24 or pixel clusters 20 are disposed on display substrate 10 using pick-and-place methods found in the printed-circuit board industry, for example using vacuum grippers. Pixels 24 or pixel clusters 20 can be interconnected on display substrate 10 using photolithographic methods and materials or printed circuit board methods and materials.

In certain embodiments, display substrate 10 includes material, for example glass or plastic, different from a material in an integrated-circuit substrate, for example a semiconductor material such as silicon or GaN. LEDs 60 can be formed separately on separate semiconductor substrates, assembled onto cluster substrates 62 or pixel substrates 64 to form pixels 24 and then the assembled units are located on the surface of cluster substrate 62 or display substrate 10. This arrangement has the advantage that the integrated circuits, pixel clusters 20, or pixels 24 can be separately tested on cluster substrate 62 or pixel substrate 64 and the pixel cluster 20 or pixel 24 modules accepted, repaired, or discarded before clusters 20 or pixels 24 are located on display substrate 10, thus improving yields and reducing costs.

In some embodiments of the present disclosure, providing dual-pixel-driver display 90, display substrate 10, pixel clusters 20, or pixels 24 can include forming conductive wires (e.g., display row wire 17, display column wire 19, cluster row wire 26, and cluster column wire 28) on display substrate 10, cluster substrate 62, or pixel substrate 64 by using photolithographic and display-substrate processing techniques, for example photolithographic processes employing metal or metal oxide deposition using evaporation or sputtering, curable resin coatings (e.g. SU8), positive or negative photo-resist coating, radiation (e.g. ultraviolet radiation) exposure through a patterned mask, and etching methods to form patterned metal structures, vias, insulating layers, and electrical interconnections. Inkjet and screen-printing deposition processes and materials can be used to form patterned conductors or other electrical elements. The electrical interconnections, or wires, can be fine interconnections, for example having a width of less than fifty microns, less than twenty microns, less than ten microns, less than five microns, less than two microns, or less than one micron. Such fine interconnections are useful for interconnecting micro-integrated circuits, for example as bare dies with contact pads and used with cluster substrate 62 and pixel substrate 64. Alternatively, wires can include one or more crude lithography interconnections having a width from 2 μm to 2 mm, wherein each crude lithography interconnection electrically interconnects circuits, device, or modules on display substrate 10. For example, electrical interconnections cluster row wire 26, and cluster column wire 28 can be formed with fine interconnections (e.g., relatively small high-resolution interconnections) while display row wire 17 and display column wire 19 are formed with crude interconnections (e.g., relatively large low-resolution interconnections).

In some embodiments, red, green, and blue LEDs 60 (e.g., micro-LEDs 600) are micro transfer printed to pixel substrates 64, cluster substrate 62, or display substrate 10 in one or more transfers and can comprise broken (e.g., fractured) or separated LED tethers 61 as a consequence of micro-transfer printing. For a discussion of micro-transfer printing techniques that can be used or adapted for use in methods disclosed herein, see U.S. Pat. Nos. 8,722,458, 7,622,367 and 8,506,867, each of which is hereby incorporated by reference in its entirety. The transferred light emitters 60 are then interconnected, for example with conductive wires and optionally including connection pads and other electrical connection structures.

In some embodiments of the present disclosure, an array of display pixels 24 (e.g., as in FIG. 1) can include at least 40,000, 62,500, 100,000, 500,000, one million, two million, three million, six million, eight million, or thirty-two million display pixels 24, for example for a quarter VGA, VGA, HD, 4K, or 8K display having various pixel densities (e.g., having at least 50, at least 75, at least 100, at least 150, at least 200, at least 300, or at least 400 pixels per inch (ppi)). In some embodiments of the present disclosure, light emitters 60 in pixels 24 can be considered integrated circuits, since they are formed in a substrate, for example a wafer substrate, or layer using integrated-circuit processes. The substrate or layer need not necessarily be silicon, for example III-V semiconductor wafers or layers can be used to form light emitters 60 using integrated-circuit processes and are considered integrated circuits (or portions thereof) in the context of this disclosure.

In some embodiments of the present disclosure, light emitters 60 are inorganic micro-light-emitting diodes 60 (micro-LEDs 60), for example having light-emissive areas of less than 10, 20, 50, or 100 square microns. In some embodiments, light emitters 60 have physical dimensions that are less than 100 μm, for example having at least one of a width from 2 to 50 μm (e.g., 2 to 5 μm, 5 to 10 μm, 10 to 20 μm, or 20 to 50 μm), a length from 2 to 50 μm (e.g., 2 to 5 μm, 5 to 10 μm, 10 to 20 μm, or 20 to 50 μm), and a height from 2 to 50 μm (e.g., 2 to 5 μm, 5 to 10 μm, 10 to 20 μm, or 20 to 50 μm). Light emitters 60 can have a size of, for example, one square micron to 500 square microns. Such micro-LEDs 60 have the advantage of a small light-emissive area compared to their brightness as well as color purity providing highly saturated display colors and a substantially Lambertian emission providing a wide viewing angle. Such small light emitters 60 also provide additional space on display substrate 10 for additional functional elements or larger wires.

In some embodiments, LEDs 60 are formed in substrates or on supports separate from display substrate 10. For example, LEDs 60 can be made in a native compound semiconductor wafer. Similarly, cluster controllers 22 can be separately formed in a semiconductor wafer such as a silicon wafer e.g., in CMOS. LEDs 60, or cluster controllers 22 are then removed from their respective source wafers and transferred, for example using micro-transfer printing, to display substrate 10, cluster substrate 62, or pixel substrate 64. Such arrangements have the advantage of using a crystalline semiconductor substrate that provides higher-performance integrated circuit components than can be made in the amorphous or polysilicon semiconductor available in thin-film circuits on a large substrate such as display substrate 10. Such micro-transferred LEDs 60 or cluster controllers 22 can comprise a broken (e.g., fractured) or separated LED tether 61 or cluster controller tether 23 as a consequence of a micro-transfer printing process.

According to various embodiments, dual-pixel-driver display 90 can include a variety of designs having a variety of resolutions, light emitter 60 sizes, and display substrate 10 areas.

By employing a multi-step transfer or assembly process, increased yields are achieved and thus reduced costs for dual-pixel driver displays 90 of the present disclosure. Additional details useful in understanding and performing aspects of the present disclosure are described in U.S. patent application Ser. No. 14/743,981, filed Jun. 18, 2015, entitled Micro Assembled Micro LED Displays and Lighting Elements, the disclosure of which is hereby incorporated by reference herein in its entirety.

As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

As is also understood by those skilled in the art, the terms “column” and “row”, “horizontal” and “vertical”, and “x” and “y”, “top” and “bottom”, and “left” and “right” are arbitrary designations that can be interchanged (unless otherwise clear from context).

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously. The disclosure has been described in detail with particular express reference to certain embodiments thereof, but it will be understood that variations and modifications can be effected within the spirit and scope of the following claims.

### PARTS LIST

10 display substrate
12 display area
14 display controller
16 display row controller
17 display row signals/display row wires
18 display column controller
19 display column wire/display column signals
20 pixel cluster/cluster
20A first pixel cluster/first cluster
20B second pixel cluster/second cluster
22 cluster controller
22C cluster column controller
22R cluster row controller
23 cluster controller tether
24 pixel/display pixel
26 cluster row wire/cluster row signal
26A first cluster row wire/first cluster row signal
26B second cluster row wire/second cluster row signal
28 cluster column wire/cluster column signal
28A first cluster column wire/first cluster column signal
28B second cluster column wire/second cluster column signal
30 pixel controller
31 pixel controller tether
60 LED/light-emitting diode/light emitter
60A first LED
60B second LED
61 LED tether
62 cluster substrate
63 cluster tether
64 pixel substrate
65 pixel tether
70 dual-pixel driver
71 first driver output
72 second driver output
73 driver input
90 dual-pixel-driver display

What is claimed:

1. A dual-pixel-driver display, comprising:
pixels distributed in an array of rows and columns defining a display area, wherein ones of the pixels are grouped in a mutually exclusive first pixel cluster and second pixel cluster; and
a dual-pixel driver disposed within the display area, the dual-pixel driver comprising a driver input, a first driver output, and a second driver output, the first driver output and the second driver output both commonly responsive to signals provided by the driver input,
wherein the first driver output is electrically connected to the first pixel cluster to drive the ones of the pixels in the first pixel cluster and the second driver output is electrically connected to the second pixel cluster to drive the ones of the pixels in the second pixel cluster.

2. The dual-pixel-driver display of claim 1, wherein the pixels comprise light controllers and the light controllers are controllable with passive-matrix control signals provided at least in part by the dual-pixel driver.

3. The dual-pixel-driver display of claim 1, wherein the pixels comprise light controllers and the light controllers are controllable with active-matrix control signals provided at least in part by the dual-pixel driver.

4. The dual-pixel-driver display of claim 3, wherein the pixels each comprise a pixel controller responsive to the active-matrix control signals.

5. The dual-pixel-driver display of claim 1, wherein ones of the pixels in each of the rows are grouped in a mutually exclusive first row pixel cluster and second row pixel cluster and the display comprises a dual-pixel driver for driving the first row pixel cluster and the second row pixel cluster.

6. The dual-pixel-driver display of claim 1, wherein ones of the pixels in each of the columns are grouped in a mutually exclusive first column pixel cluster and second column pixel cluster and the display comprises a dual-pixel driver for driving the first column pixel cluster and the second column pixel cluster.

7. The dual-pixel-driver display of claim 1, wherein each of the pixels comprise an inorganic light-emitting diode.

8. The dual-pixel-driver display of claim 7, wherein the inorganic light-emitting diode comprises a bare unpackaged die with a separate, individual, and independent LED substrate and a broken (e.g., fractured) or separated tether.

9. The dual-pixel-driver display of claim 1, wherein each of ones of the pixels in each of the rows are grouped in a mutually exclusive first row pixel cluster or second row pixel cluster, each of ones of the pixels in each of the columns are grouped in a mutually exclusive first column pixel cluster or second column pixel cluster and the display comprises a dual-pixel driver for driving the first row pixel cluster and the second row pixel cluster and a dual-pixel driver for driving the first column pixel cluster and the second column pixel cluster.

10. The dual-pixel-driver display of claim 9, comprising a row cluster controller for controlling the first row pixel cluster and the second row pixel cluster and a column cluster controller for controlling the first column pixel cluster and the second column pixel cluster.

11. The dual-pixel-driver display of claim 10, wherein the row cluster controller and the column cluster controller are disposed in a common integrated circuit.

12. The dual-pixel-driver display of claim 10, wherein the row cluster controller and the column cluster controller are disposed in separate integrated circuits.

13. The dual-pixel-driver display of claim 1, wherein the number of pixels in the first pixel cluster equals the number of pixels in the second pixel cluster.

14. The dual-pixel-driver display of claim 1, wherein the first driver output and the second driver output are separately enabled.

15. The dual-pixel-driver display of claim 1, comprising a cluster controller disposed within the display area, wherein the cluster controller comprises the dual-pixel driver.

16. The dual-pixel-driver display of claim 15, wherein the cluster controller comprises a bare unpackaged die with a separate, individual, and independent cluster-controller substrate and a broken (e.g., fractured) or separated tether.

17. The dual-pixel-driver display of claim 15, comprising a display controller that provides active-matrix signals to the cluster controller.

18. The dual-pixel-driver display of claim 1, wherein:
the pixels are grouped into first pixel clusters and second pixel clusters and the first pixel clusters and the second pixel clusters are mutually exclusive,
the display comprises a respective dual-pixel driver disposed within the display area, the respective dual-pixel driver comprising a respective driver input, a respective first driver output, and a respective second driver output, the respective first driver output and the respective second driver output both commonly responsive to one or more signals provided by the respective driver input, and
the respective first driver output is electrically connected to one of the first pixel clusters to drive the pixels in the one of the first pixel clusters and the respective second driver output is electrically connected to one of the second pixel clusters to drive the pixels in the one of the second pixel clusters.

19. The dual-pixel-driver display of claim 18, comprising a cluster controller disposed within the display area, wherein the cluster controller comprises the dual-pixel driver and wherein the cluster controller is operable to control more than one pixel cluster among the first pixel clusters and the second pixel clusters.

20. The dual-pixel-driver display of claim 19, wherein (i) the number of first pixel clusters is less than the number of pixels in the first pixel cluster (ii) the number of second pixel clusters is less than the number of pixels in the second pixel cluster, or (iii) both (i) and (ii).

21. The dual-pixel-driver display of claim 18, comprising multiple cluster controllers, each of the cluster controllers driving different ones of the first pixel clusters and the second pixel clusters.

22. The dual-pixel-driver display of claim 1, wherein the pixels and the dual-pixel driver are comprised in a backlight.

23. The dual-pixel-driver display of claim 22, wherein each of the pixels corresponds to a local-dimming zone of the backlight.

24. The dual-pixel-driver display of claim 1, comprising multiple pairs of mutually exclusive first pixel clusters and second pixel clusters and wherein the first driver output is electrically connected to the first pixel clusters to drive ones of the pixels in the first pixel clusters and the second driver output is electrically connected to the second pixel clusters to drive ones of the pixels in the second pixel clusters.

25. A dual-pixel-driver backlight for a display, comprising:
pixels distributed in an array of rows and columns defining a display area, wherein each of ones of the pixels are grouped in a mutually exclusive first pixel cluster or second pixel cluster; and
a dual-pixel driver disposed within the display area, the dual-pixel driver comprising a driver input, a first driver output, and a second driver output, the first driver output and the second driver output both commonly responsive to signals provided by the driver input,
wherein the first driver output is electrically connected to the first pixel cluster to drive the ones of the pixels in the first pixel cluster and the second driver output is electrically connected to the second pixel cluster to drive the ones of the pixels in the second pixel cluster.
